(19) United States
(12) Patent Application Publication
(10) Pub. No.: US 2008/0172225 A1
(43) Pub. Date: Jul. 17, 2008

(54) APPARATUS AND METHOD FOR PRE-PROCESSING SPEECH SIGNAL

(75) Inventors: Gang-Youl KIM, Suwon-si (KR); Beak-Kwon Son, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/964,506

(22) Filed: Dec. 26, 2007

(30) Foreign Application Priority Data
Dec. 26, 2006 (KR) 2006-133766

(51) Int. Cl. G10L 15/20

(52) U.S. Cl. 704/233; 704/E15.001

(57) ABSTRACT

An apparatus for pre-processing a speech signal capable of improving the performance of speech signal processing by extracting the characteristics of noise that are distinguished from those of speech, and a method for extracting a speech end-point for the apparatus are provided. The apparatus includes a noise/speech determination unit for calculating noise information from at least one of an initial frame and a final frame of an input speech signal and determining if a current frame of the speech signal is a noise frame or a speech frame using the noise information, a hangover application unit for determining a predetermined number of frames transmitted after the current frame as consecutive speech frames when the current frame is the speech frame, and a speech information update unit for storing the speech frame and the consecutive speech frames. Noise information can be accurately calculated by using at least one of an initial noise frame and a final noise frame and continuously updating the noise information.

### PRIORITY

This application claims priority under 35 U.S.C. § 119(a) to a Korean Patent Application filed in the Korean Intellectual Property Office on Dec. 26, 2006 and assigned Ser. No. 2006-133766, the entire disclosure of which is incorporated herein by reference.

### BACKGROUND OF THE INVENTION

1. Field of the Invention

The present invention relates generally to an apparatus and method for pre-processing a speech signal, and in particular, to an apparatus and method for pre-processing a speech signal for improving the performance of speech recognition.

2. Description of the Related Art

Generally, speech signal processing has been used in various application fields such as speech recognition for allowing computer devices or communication devices to recognize analog human speech, speech synthesis for synthesizing human speech using the computer devices or the communication devices, speech coding, and the like. Speech signal processing has become more important than ever as an element technique for a human-computer interface and has come into wide use in various fields for serving human convenience such as home automation, communication devices, such as speech-recognizing mobile terminals and speaking robots.

As various multimedia functions are integrated with mobile terminals, a User Interface (UI) for using the mobile terminals is becoming complex. As a result, a Voice User Interface (VUI) using a speech recognition function is required in the mobile terminals having various multimedia functions.

Recently, UI functions using speech recognition, such as access to a complex menu with a single try using a voice command function, as well as a name and phone number search function have been reinforced in mobile terminals. However, the performance of speech recognition degrades significantly due to special environmental factors of the mobile terminal, i.e., various background noises. Therefore, there is a need for an apparatus and method for accurately extracting speech under the coexistence of speech and noise as a pre-processing technique for performance improvement in speech recognition that minimizes influences of various background noises to improve the VUI performance of the mobile terminal.

In speech recognition, the pre-processing technique involves extracting the characteristics of speech for digital speech signal processing and the quality of a digital speech signal depends on the pre-processing technique.

A conventional pre-processing technique for extracting a speech end-point distinguishes a speech frame from a noise frame using energy information of an input speech signal as a main factor. It is assumed that several initial frames of an input speech signal are noise frames.

The conventional pre-processing technique calculates average values of energies and zero-crossing rates from the initial noise frames to calculate the statistical characteristics of noise. The conventional pre-processing technique then calculates threshold values of energies and zero-crossing rates from the calculated average values and determines if an input frame is a speech frame or a noise frame based on the threshold values.

Energy is used to distinguish between a speech frame and a noise frame based on the fact that the energy of speech is greater than that of noise. An input frame is determined as a speech frame if the calculated energy of the input frame is greater than an energy threshold value calculated in a noise frame. An input frame is determined as a noise frame if the calculated energy is less than the energy threshold value. The distinguishment using a zero-crossing rate is based on the fact that noise has a more number of zero-crossings than that of speech due to the greatly changing and irregular waveform of noise.

As described above, the conventional pre-processing technique for extracting a speech end-point determines the statistical characteristics of noise for all frames using an initial noise frame having noise. However, noise generated in an actual environment, such as non-stationary babble noise, noise generated during movement by automobile, and noise generated during movement by subway is converted into various forms during speech processing. As a result, if an input frame is determined as a speech frame based on a threshold value calculated using an initial noise frame, a noise frame may also be extracted as a speech frame. In a signal having much noise, the energy of noise is similar to that of speech and the zero-crossing rate of speech is similar to that of noise due to an influence of noise, hindering accurate extraction of a speech end-point.

Therefore, there is a need for a pre-processing technique for extracting a speech end-point using the characteristics of a noise frame including noise generated in an actual environment

### SUMMARY OF THE INVENTION

An aspect of the present invention is to solve at least the above problems and/or disadvantages and to provide at least the advantages described below. Accordingly, an aspect of the present invention is to provide an apparatus and method for pre-processing a speech signal in which the performance of speech signal processing can be improved by extracting the characteristics of noise that are distinguished from those of speech.

According to an aspect of the present invention, there is provided an apparatus for pre-processing a speech signal, which extracts a speech end-point. The apparatus includes a noise/speech determination unit for calculating noise information from at least one of an initial frame and a final frame of an input speech signal and determining if a current frame of the speech signal is a noise frame or a speech frame using the noise information, a hangover application unit for determining a predetermined number of frames transmitted after the current frame as consecutive speech frames when the current frame is the speech frame, and a speech information update unit for storing the speech frame and the consecutive speech frames.

According to another aspect of the present invention, there is provided a method for extracting a speech end-point in an apparatus for pre-processing a speech signal. The method includes calculating noise information from at least one of an initial frame and a final frame of an input speech signal and determining if a current frame of the speech signal is a noise frame or a speech frame using the noise information, determining a predetermined number of frames transmitted after the current frame as consecutive speech frames when the current frame is the speech frame, and storing the speech frame and the consecutive speech frames.

### BRIEF DESCRIPTION OF THE DRAWINGS

The above and other features and advantages of the present invention will become more apparent from the following detailed description when taken in conjunction with the accompanying drawings, in which:

FIG. 1 is a block diagram of an apparatus for pre-processing a speech signal to which a method for extracting a speech end-point is applied according to the present invention;

FIG. 2 is a flowchart illustrating a method for extracting a speech end-point according to the present invention;

FIG. 3 is a detailed flowchart illustrating the process of determining noise and speech, illustrated in FIG. 2;

FIG. 4 illustrates a speech frame including speech in an input speech signal;

FIG. 5 illustrates a result acquired by speech end-point extraction according to the prior art; and

FIG. 6 illustrates results acquired by speech end-point extraction according to the present invention.

### DETAILED DESCRIPTION OF THE EXEMPLARY EMBODIMENT

The matters defined in the description such as a detailed construction and elements are provided to assist in a comprehensive understanding of an exemplary embodiment of the invention. Accordingly, those of ordinary skill in the art will recognize that various changes and modifications of the embodiment described herein can be made without departing from the scope and spirit of the invention. Also, descriptions of well-known functions and constructions are omitted for clarity and conciseness.

Terms used herein are defined based on functions in the present invention and may vary according to users, operators' intention or usual practices. Therefore, the definition of the terms should be made based on contents throughout the specification. Throughout the drawings, the same drawing reference numerals will be understood to refer to the same elements, features and structures.

When an analog speech signal is input for speech recognition according to an exemplary embodiment of the present invention, a speaker usually speaks after a lapse of a predetermined time from a point of time at which the speech signal can be input. Thus, a frame corresponding to initial (first) several seconds is assumed to be a noise frame containing noise information during which speech is absent. The input of the speech signal is substantially terminated after a lapse of some time from a point of time at which the speaker finishes an utterance. Thus, a frame corresponding to final (last) several seconds is assumed to be a noise frame containing noise information during which speech is absent.

Under those assumptions, the present invention updates noise information based on at least one of the initial noise frame and the final noise frame. When the noise information is updated based on the initial noise frame, a speech end-point is extracted in a forward direction of an input speech signal frame. When the noise information is updated based on the final noise frame, a speech end-point is extracted in a backward direction of the input speech signal frame.

According to an exemplary embodiment of the present invention, a method for extracting a speech end-point in the forward direction and a method for extracting a speech end-point in the backward direction may be executed in a serial or parallel manner in an apparatus for pre-processing a speech signal according to a way to implement the apparatus.

The number of frames to which the method for extracting a speech end-point in the forward direction is applied and the number of frames to which the method for extracting a speech end-point in the backward direction is applied may change according to the way to implement the apparatus.

As such, the present invention can minimize a delay in extraction of a speech end-point by extracting the speech end-point in the forward direction and/or in the backward direction, and can extract the speech end-point by using accurate noise information based on at least one of an initial noise frame and a final noise frame.

Hereinafter, an apparatus for pre-processing a speech signal and a method for extracting a speech end-point for the apparatus according to an exemplary embodiment of the present invention will be described with reference to the accompanying drawings.

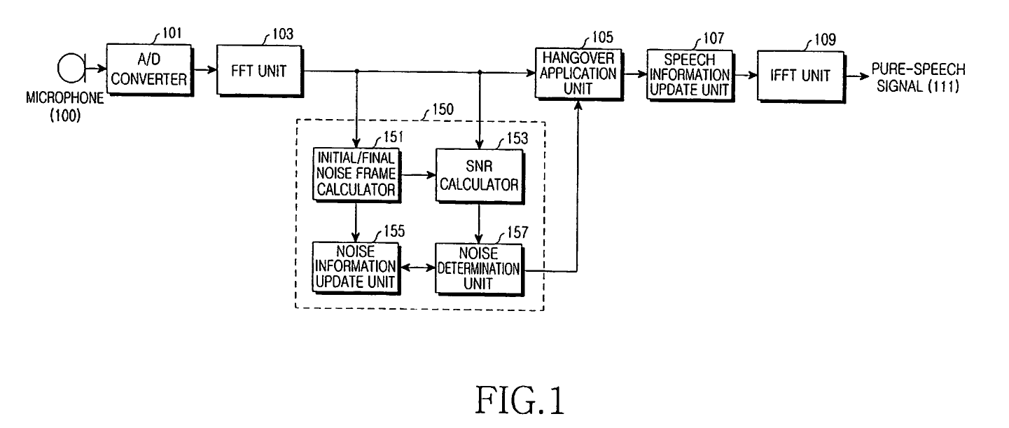

FIG. 1 is a block diagram of an apparatus for pre-processing a speech signal to which a method for extracting a speech end-point is applied according to an exemplary embodiment of the present invention. Referring to FIG. 1, the apparatus includes an Analog-to-Digital (A/D) converter 101, a Fast Fourier Transform (FFT) unit 103, a noise/speech determination unit 150, a hangover [How do you define “Hangover”] application unit 105, a speech information update unit 107, and an Inverse Fast Fourier Transform (IFFT) unit 109. The noise/speech determination unit 150 includes an initial/final noise frame calculator 151, a Signal-to-Noise Ratio (SNR) calculator 153, a noise information update unit 155, and a noise determination unit 157 to determine noise and speech based on at least one of an initial noise frame and a final noise frame.

In FIG. 1, the A/D converter 101 converts user's analog speech, which is input through a microphone 100, into a digital speech signal, e.g., a Pulse Code Modulation (PCM) signal. The FFT unit 103 transforms a digital speech signal frame into a frequency domain.

The initial/final noise frame calculator 151 calculates noise information using the energy of an initial or final noise frame under the above-described assumptions as Equation (1):

$${E}_{N} = \frac{{\sum }_{M} {E}_{n}}{M} , \qquad ( 1 )$$

where M indicates the number of initial or final noise frames and Eₙ indicates the energy of an initial or final noise frame. Thus, according to an exemplary embodiment of the present invention, an average value of the energies of the initial or final noise frames is used as noise information.

The SNR calculator 153 calculates a ratio of the energy of speech to the energy of noise as Equation (2):

$$SNR = 20 log \frac{{E}_{S}}{{E}_{N}} , \qquad ( 2 )$$

where Eₛ indicates the energy of the current frame and E_{N} indicates the noise information calculated using Equation (1).

In FIG. 1, the noise information update unit 155 updates and stores noise information of an initial or final noise frame and noise information of a frame determined as a noise frame by the noise determination unit 157. A way for the noise information update unit 155 to update and store the noise information of the frame determined as a noise frame will be described below.

The noise determination unit 157 compares the SNR of the current frame, which is calculated by the SNR calculator 153, with the noise information stored in the noise information update unit 155. The noise determination unit 157 determines the current frame as a noise frame when the SNR of the current frame is greater than the noise information and determines the current frame as a speech frame when the SNR of the current frame is less than the noise information. When the noise determination unit 157 determines the current frame as the noise frame, it transmits the current frame to the noise information update unit 155. When the noise determination unit 157 determines the current frame as the speech frame, it transmits the current frame to the hangover application unit 105.

Upon receipt of the current frame, the noise information update unit 155 updates the stored noise information using the received current frame. The noise information is updated as Equation (3):

E_{N,n}=E_{N,n-1}*α+Eₛ*(1−α), 0<α<1 (3),

where E_{N,n-1} indicates previous noise information, Eₛ indicates the energy of the current frame, and α indicates noise information of the current frame, and weights the previous noise information when being multiplied by the previous noise information and weights the energy of the current frame when being multiplied by the energy of the current frame, thereby updating the noise information. α also determines the speed of update.

When the noise determination unit 157 determines the current frame as a speech frame, the hangover application unit 105 determines several frames transmitted after the current frame as speech frames, thereby preventing erroneous extraction caused by a short noise frame generated in the speech signal. A way for the hangover application unit 105 to determine several frames transmitted after the current frame as speech frames includes setting a threshold value of a hangover counter within a predetermined minimum speech length that is so preset experimentally as to prevent an error in speech frame detection and determining the transmitted frames as speech frames when the number of transmitted frames does not exceed the threshold value.

When a speech update flag is set to ON, the speech information update unit 107 stores the frame determined as the speech frame in a preset speech buffer (not shown). The IFFT unit 109 performs IFFT on speech determined as the speech frame to output a pure-speech signal 111 in which noise is absent.

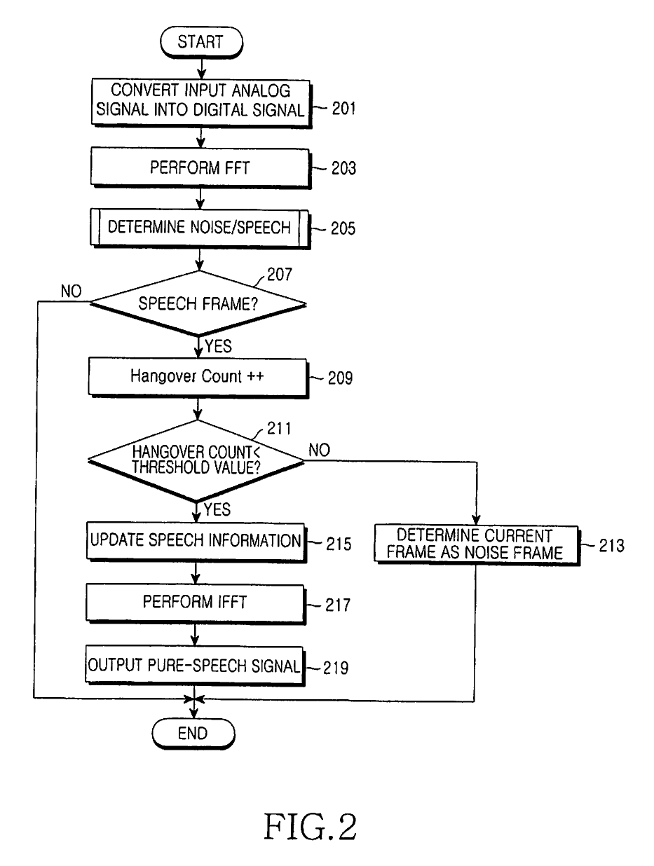

FIG. 2 is a flowchart illustrating a method for extracting a speech end-point according to an exemplary embodiment of the present invention. Referring to FIG. 2, in step 201, the A/D converter 101 converts user's analog speech, which is input through the microphone 100, into a digital speech signal, e.g., a PCM signal. In step 203, the FFT unit 103 transforms a digital speech signal frame into a frequency domain.

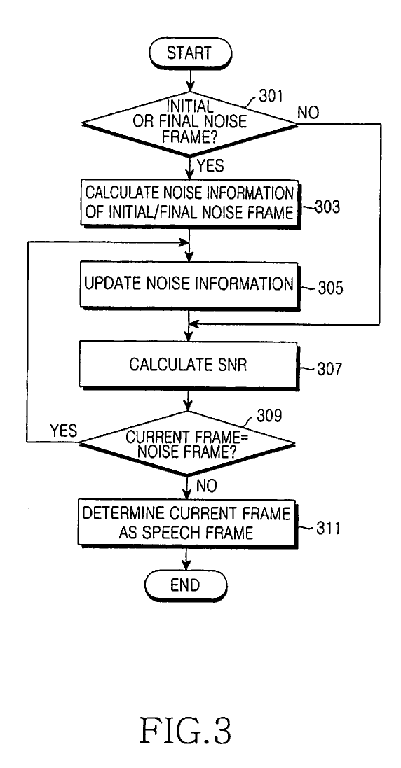

In step 205, the noise/voice determination unit 150 calculates noise information using at least one of an initial noise frame and a final noise frame and calculates the SNR of the current frame of an input speech signal to determine if the current frame is a noise frame or a speech frame. The determination of whether the current frame is the noise frame or the speech frame will be described in more detail with reference to FIG. 3.

In step 207, the noise/speech determination unit 150 goes to step 209 when it determines the current frame as the speech frame, and terminates its operation when it determines the current frame as the noise frame.

In step 209, the hangover application unit 105 counts the number of frames transmitted after the current frame determined as the speech frame. In step 211, the hangover application unit 105 determines if the counted number of frames exceeds a threshold value of a hangover counter, which has been set within a minimum speech length. When the number of transmitted frames is less than the threshold value of the hangover counter, the hangover application unit 105 goes to step 215. When the number of transmitted frames exceeds the threshold value, the hangover application unit 105 goes to step 213. In steps 209 and 211, the hangover application unit 105 determines the several frames transmitted after the current frame, which has been determined as the speech frame, thereby preventing erroneous extraction caused by a short noise frame generated in the speech signal.

In step 215, when the speech update flag is set to ON, the speech information update unit 107 stores the frames determined as the speech frames in a preset speech buffer (not shown). The IFFT unit 109 performs IFFT on speech determined as the speech frames in step 217 and outputs a pure-speech signal where noise is absent in step 219.

FIG. 3 is a detailed flowchart illustrating the process of determining noise and speech, illustrated in FIG. 2. Referring to FIG. 3, in step 301, the initial/final noise frame calculator 151 determines if the input current frame is one of an initial frame and a final frame. When the current frame is one of the initial frame and the final frame, the initial/final noise frame calculator 151 goes to step 303. Otherwise, the initial/final noise frame calculator 151 goes to step 307. In step 303, the initial/final noise frame calculator 151 calculates noise information using Equation (1). In step 305, the noise information update unit 305 updates the noise information using the calculated noise information and the current frame when the current frame is determined as a noise frame in step 309. The noise information is updated using Equation (3).

In step 307, the SNR calculator 153 calculates a ratio of the energy of speech to the energy of noise using Equation (2). In step 309, the noise determination unit 157 determines if the current frame is a noise frame by comparing the calculated ratio of the current frame with the update noise information. When the SNR of the current frame is greater than the noise information, the noise determination unit 157 determines the current frame as a noise frame and goes to step 305. When the SNR of the current frame is less than the noise information, the noise determination unit 157 goes to step 311 and determines the current frame as a speech frame in step 311.

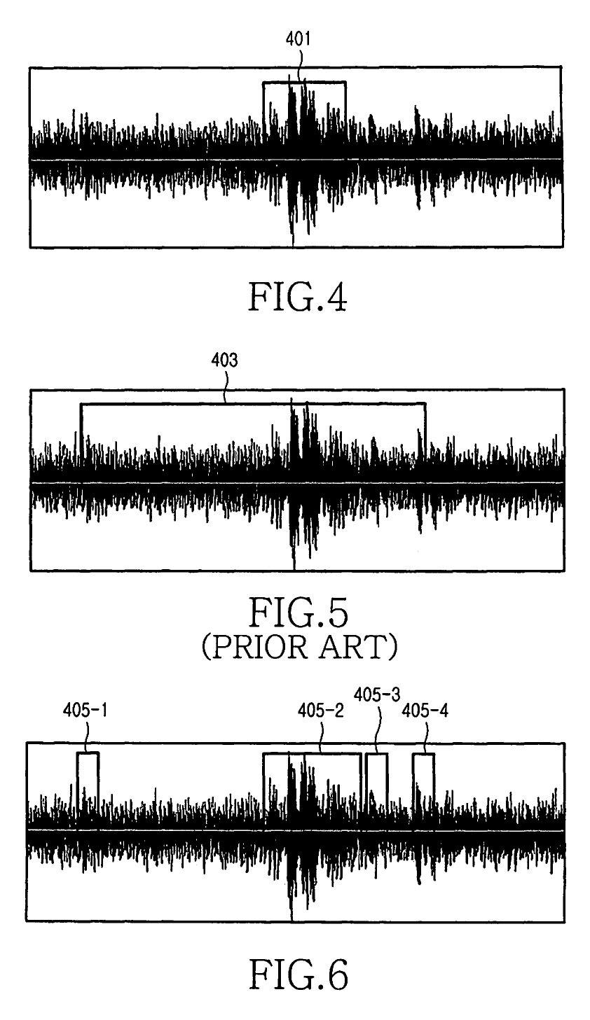

Hereinafter, the accuracy of speech end-point extraction with respect to an input speech signal according to the prior art and the accuracy of speech end-point extraction with respect to the input speech signal according to an exemplary embodiment of the present invention will be described with reference to FIGS. 4 through 6.

FIG. 4 illustrates a speech frame including speech 401 in an input speech signal.

FIG. 5 illustrates a result 403 acquired by speech end-point extraction according to the prior art, in which the speech end-point extraction result 403 is acquired by calculating an initial noise frame in an input speech signal as noise information. As illustrated in FIG. 5, an initial portion is a long noise frame in a frame from which a speech end-point is extracted, but the noise frame may be mistakenly extracted as a speech frame due to erroneous extraction of the initial noise frame.

FIG. 6 illustrates results 405-1 through 405-4 acquired by speech end-point extraction according to an exemplary embodiment of the present invention, in which the speech end-point extraction results 405-1 through 405-4 are acquired by calculating initial and final noise frames as noise information in an input speech signal. In FIG. 6, according to an exemplary embodiment of the present invention, a speech-end point can be accurately extracted based on at least one of the initial noise frame and the final noise frame. Even when at least one of the initial noise frame and the final noise frame is extracted erroneously, an influence of noise can be minimized by updating a noise frame and a speech frame on a real-time basis according to an exemplary embodiment of the present invention.

As is apparent from the foregoing description, according to the present invention, noise information can be accurately calculated by using at least one of an initial noise frame and a final noise frame and continuously updating the noise information.

Moreover, an error in speech end-point extraction due to determination of a noise frame as a speech frame can be minimized using hangover, thereby improving the performance of speech processing.

Furthermore, speech end-point extraction is performed in a serial or parallel manner based on an initial noise frame and a final noise frame, thereby reducing processing delay time.

While the invention has been shown and described with reference to a certain exemplary embodiment thereof, it will be understood by those skilled in the art that various changes in form and details may be made therein without departing from the spirit and scope of the invention as defined by the appended claims.

What is claimed is:

1. An apparatus for pre-processing a speech signal, which extracts a speech end-point, the apparatus comprising:
a noise/speech determination unit for calculating noise information from at least one of an initial frame and a final frame of an input speech signal and determining if a current frame of the speech signal is a noise frame or a speech frame using the noise information;
a hangover application unit for determining a predetermined number of frames transmitted after the current frame as consecutive speech frames when the current frame is the speech frame; and
a speech information update unit for storing the speech frame and the consecutive speech frames.

2. The apparatus of claim 1, wherein the noise/speech determination unit comprises:
a noise frame calculator for calculating the noise information;
a Signal-to-Noise Ratio (SNR) calculator for calculating a ratio of an energy of the current frame to an energy of the noise information;
a noise determination unit for determining the current frame as the noise frame when the calculated ratio is greater than the noise information; and
a noise information update unit for updating the noise information using the calculated noise information and the current frame determined as the noise frame.

3. A method for extracting a speech end-point in an apparatus for pre-processing a speech signal, the method comprising:
calculating noise information from at least one of an initial frame and a final frame of an input speech signal and determining if a current frame of the speech signal is a noise frame or a speech frame using the noise information;
determining a predetermined number of frames transmitted after the current frame as consecutive speech frames when the current frame is the speech frame; and
storing the speech frame and the consecutive speech frames.

4. The method of claim 3, wherein the calculating noise information and the determining if the current frame is the noise frame or the speech frame comprises:
calculating the noise information; and
calculating a ratio of an energy of the current frame to an energy of the noise information.

5. The method of claim 4, further comprising determining the current frame as the noise frame when the calculated ratio is greater than the noise information.

6. The method of claim 5, further comprising updating the noise information using the calculated noise information and the current frame determined as the noise frame.
